(19) United States
(12) Patent Application Publication
(10) Pub. No.: US 2026/0105673 A1
(43) Pub. Date: Apr. 16, 2026

(54) SYSTEMS AND METHODS FOR ANIMATING REALISTIC MOVEMENTS IN AN AVATAR USING A CO-SPEECH ENGINE

(71) Applicants: Constructor Technology AG, Schaffhausen (CH); Constructor Education and Research Genossenschaft, Schaffhausen (CH)

(72) Inventors: Sergey ULASEN, Singapore (SG); Andrei BOIAROV, Sofia (BG); Kseniia ALEKSEITSEVA, Sofia (BG); Serg BELL, Singapore (SG); Stanislav PROTASOV, Singapore (SG); Nikolay DOBROVOLSKIY, Alanya (TR); Laurent DEDENIS, Singapore (SG)

(21) Appl. No.: 18/915,439

(22) Filed: Oct. 15, 2024

(51) Int. Cl. G06T 13/40; G06T 13/20; G10L 15/02; G10L 15/08

(52) U.S. Cl. CPC G06T 13/40; G06T 13/205; G10L 15/02; G10L 15/08; G10L 2015/088

(57) ABSTRACT

Disclosed herein are systems and methods for generating realistic movements for a virtual avatar. An exemplary method includes: extracting, using a speech recognition algorithm, a plurality of words from an audio clip; inputting the plurality of words into a machine learning model configured to output a plurality of gestures to accompany the plurality of words, wherein the machine learning model is configured to: detect a group of words; identify a keyword in the group of words; and assign, to the group of words, a gesture corresponding to the keyword; and animating a virtual avatar to perform the outputted plurality of gestures while reciting the plurality of words, wherein the gesture is performed when reciting the group of words.

### FIELD OF TECHNOLOGY

The present disclosure relates to the field of virtual simulation, and, more specifically, to systems and methods for generating realistic movements for a virtual avatar.

### BACKGROUND

In recent years, advancements in technology have brought forth remarkable achievements in graphics. However, one area that remains conspicuously underdeveloped is the simulation of body language and gestures in generated virtual avatars. While these technologies have made strides in creating immersive experiences and lifelike simulations, the representation of gestures has often fallen short of realistic expectations. This inadequacy highlights a significant gap in current capabilities, where the subtleties of human gestures and artistic expression have proven challenging to replicate convincingly in virtual environments. Consequently, despite the promise and potential of virtual simulations, the fidelity of body language and gestures in creative activities remains a poignant reminder of the complexities that technology has yet to master.

### SUMMARY

Aspects of the present disclosure describe methods and systems for animating realistic movements in an avatar using a co-speech engine.

In some aspects, the techniques described herein relate to a method for generating realistic movements for a virtual avatar, the method including: extracting, using a speech recognition algorithm, a plurality of words from an audio clip; inputting the plurality of words into a machine learning model configured to output a plurality of gestures to accompany the plurality of words, wherein the machine learning model is configured to: detect a group of words; identify a keyword in the group of words; and assign, to the group of words, a gesture corresponding to the keyword; and animating a virtual avatar to perform the outputted plurality of gestures while reciting the plurality of words, wherein the gesture is performed when reciting the group of words.

In some aspects, the techniques described herein relate to a method, wherein the group of words is a phrase and/or a complete sentence.

In some aspects, the techniques described herein relate to a method, wherein the plurality of words are each assigned a timestamp based on an occurrence in the audio clip, further including: inputting, in the machine learning model, timestamps assigned to the plurality of words, wherein the machine learning model is configured to generate an output time period for each of the plurality of gestures, wherein the output time period starts from a first timestamp of when the group of words begins to a second timestamp of when the group of words ends, and wherein the virtual avatar performs the plurality of gestures at a pace matching the audio clip.

In some aspects, the techniques described herein relate to a method, further including: determining a tone of a voice speaking the plurality of words in the audio clip; inputting, in the machine learning model, a tone of the plurality of words, wherein the machine learning model is configured to select the plurality of gestures based on the tone such that the group of words stated in a first tone are assigned the gesture and the group of words stated in a second tone are assigned a different gesture.

In some aspects, the techniques described herein relate to a method, wherein the machine learning model is trained on a dataset including input groups of words each preassigned to an output gesture.

In some aspects, the techniques described herein relate to a method, wherein the dataset includes a plurality of gesture variations for a given group of words.

In some aspects, the techniques described herein relate to a method, wherein the gesture is initiated by the avatar when reciting the keyword in the group of words.

It should be noted that the methods described above may be implemented in a system comprising a hardware processor. Alternatively, the methods may be implemented using computer executable instructions of a non-transitory computer readable medium.

In some aspects, the techniques described herein relate to a system for generating realistic movements for a virtual avatar, including: at least one memory; at least one hardware processor coupled with the at least one memory and configured, individually or in combination, to: extract, using a speech recognition algorithm, a plurality of words from an audio clip; input the plurality of words into a machine learning model configured to output a plurality of gestures to accompany the plurality of words, wherein the machine learning model is configured to: detect a group of words; identify a keyword in the group of words; and assign, to the group of words, a gesture corresponding to the keyword; and animate a virtual avatar to perform the outputted plurality of gestures while reciting the plurality of words, wherein the gesture is performed when reciting the group of words.

In some aspects, the techniques described herein relate to a non-transitory computer readable medium storing thereon computer executable instructions for generating realistic movements for a virtual avatar, including instructions for: extracting, using a speech recognition algorithm, a plurality of words from an audio clip; inputting the plurality of words into a machine learning model configured to output a plurality of gestures to accompany the plurality of words, wherein the machine learning model is configured to: detect a group of words; identify a keyword in the group of words; and assign, to the group of words, a gesture corresponding to the keyword; and animating a virtual avatar to perform the outputted plurality of gestures while reciting the plurality of words, wherein the gesture is performed when reciting the group of words.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for generating realistic movements for a virtual avatar.

FIG. 2 is a diagram illustrating an avatar writing notes on a board.

FIG. 3 is a diagram illustrating a comparison of two writing sequences.

FIG. 4 is a diagram illustrating an avatar drawing a graphic based on inertial mass.

FIG. 5 is a diagram illustrating an avatar performing a sequence of gestures based on the dialogue being output.

FIG. 6 is a diagram illustrating an avatar performing another sequence of gestures based on the dialogue being output.

FIG. 7 is a diagram illustrating an avatar performing yet another sequence of gestures based on the dialogue being output.

FIG. 8 illustrates a flow diagram of a method for rendering a video of an avatar with realistic handwriting movements.

FIG. 9 illustrates a flow diagram of a method for generating realistic handwriting movements for a virtual avatar.

FIG. 10 illustrates a flow diagram of a method for animating realistic movements in an avatar using a co-speech engine.

FIG. 11 presents an example of a general-purpose computer system on which aspects of the present disclosure can be implemented.

### DETAILED DESCRIPTION

Exemplary aspects are described herein in the context of a system, method, and computer program product for generating realistic movements for a virtual avatar. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

The systems and methods of the present disclosure thus relate to information technologies and computer animation. The systems and methods may be used to provide opportunities to create lectures with an avatar that realistically reproduces movements of a human lecturer/teacher.

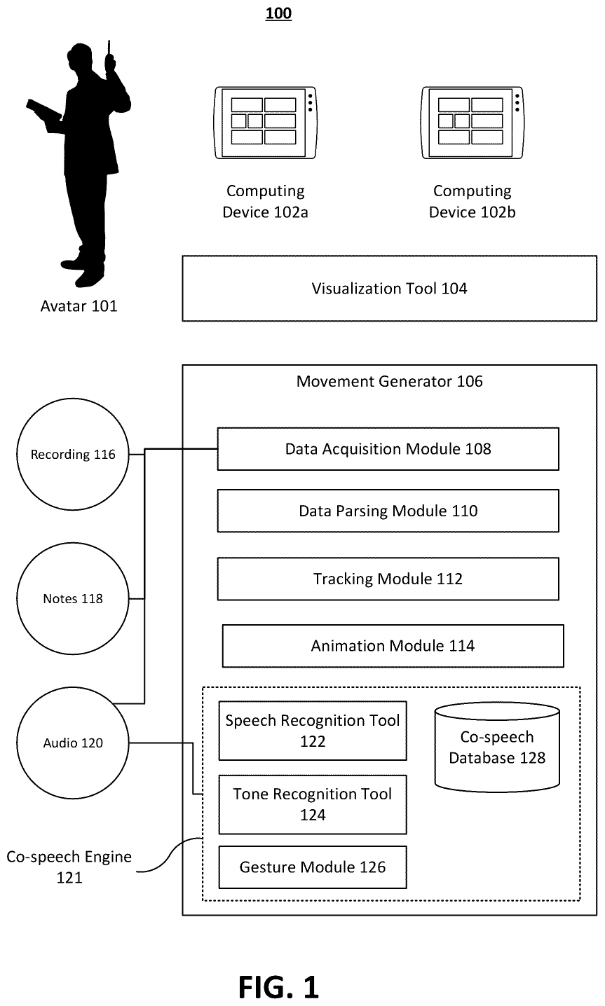

FIG. 1 is a block diagram illustrating system 100 for generating realistic movements for a virtual avatar. The first aspect of generating realistic movements involves generating realistic hand movements of an avatar. The second aspect of generating realistic movements involves generating realistic body language and gestures of the avatar.

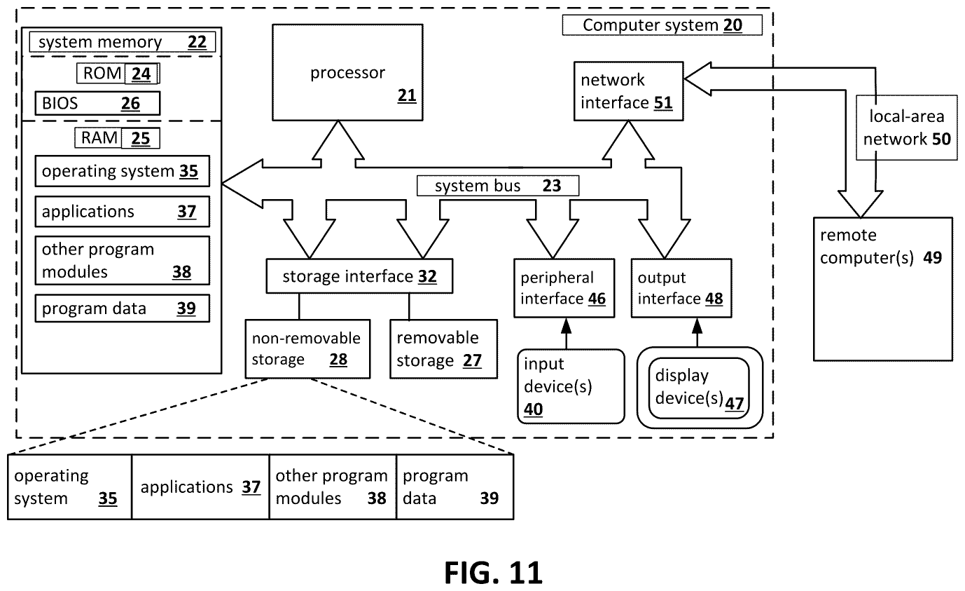

System 100 includes computing device 102a and computing device 102b. The former may be used to output avatar 101. The latter may be used to generate the movements to be performed by avatar 101 (e.g., execute movement generator 106). For example, computing device 102a may be a computer system 20 (described in FIG. 11) that is used by an end user to access a user interface. Computing device 102b may be a computer system 20 that is a remote server used for heavy processing (e.g., executing algorithms of movement generator 106).

The visuals of avatar 101 may be created using a visualization tool 104. For example, avatar 101 may be visualized as a professor or a lecturer. In some aspects, the clothes, facial features, and body structure may be modified based on user preference.

In some aspects, avatar 101 may be a hologram generated by a hologram generator device. For example, computing device 102a may use a combination of optics, lasers, and/or physical screens to create the illusion of three-dimensional images floating in space. For example, device 102a may be a holographic projector that uses advanced optics and lasers to create true holographic images such as that of avatar 101.

In some aspects, avatar 101 may not be physically generated by a hologram generator device. Instead, avatar 101 may be seen by a student using an augmented reality, virtual reality, or mixed reality headset. For example, computing device 102a may coordinate with the headset such that the visual of avatar 101 is overlaid on an image captured by the headset of the surrounding environment.

In yet some other aspects, avatar 101 may be a 2D image overlaid on a screen of computing device 102a. For example, computing device 102a may be a desktop computer and the avatar 101 may be generated on the display of the desktop computer as a 2D image.

The movement of avatar 101 may be created using movement generator 106. Movement generator 106 may include data acquisition module 108, data parsing module 110, tracking module 112, animation module 114, speech recognition tool 122, tone recognition tool 124, and gesture module 126.

The input of movement generator 106 is a recording 116 comprising a video of a lecture. In particular, the video may show notes 118 being handwritten on a blank canvas. In some aspects, recording 116 may include audio 120 of the writer narrating as he/she writes notes 118. Suppose that the video is posted on a media streaming platform (e.g., YouTube) and a user is interested in generating an interactive version of the video where avatar 101 presents the notes as a live human (e.g., a tutor) would. As is, the video may simply show words, equations, or drawings being made.

With the combination of visualization tool 104 and movement generator 106, the output of system 100 is an interactive version of recording 116 in which avatar 101 is (1) shown to hand write the notes, (2) configured to receive user questions and generate responses, and (3) make gestures and movements based on an audio and/or the contents of the notes.

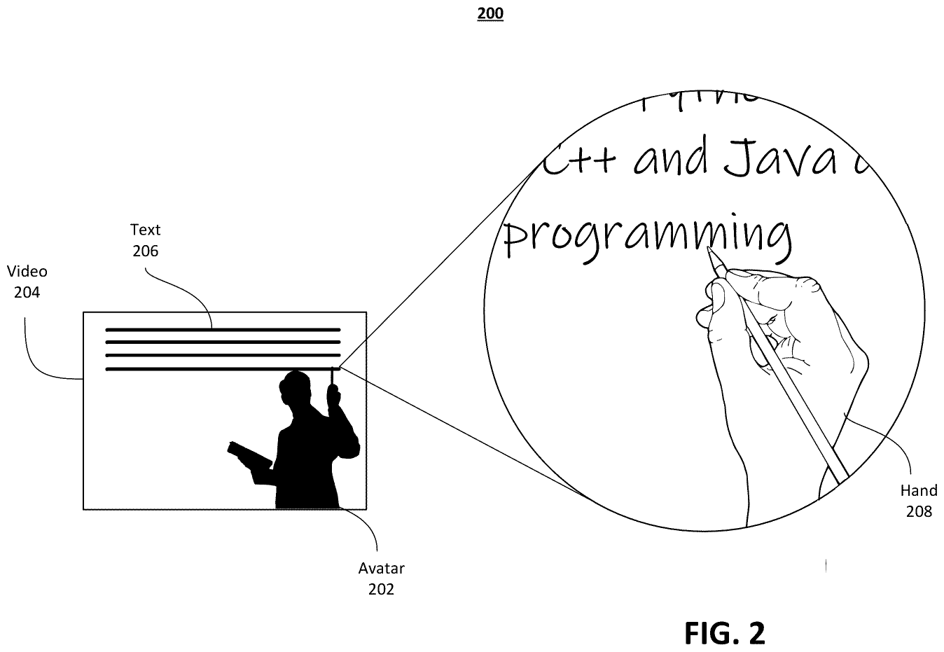

FIG. 2 is a diagram 200 illustrating an avatar writing notes on a board. In diagram 200, avatar 202 is shown to write text 206 in video 204. Upon zooming into video 204, it can be seen that hand 208 is writing the word “programming.” Video 204 is an output of system 100. The motion of avatar 202, particularly the motion of writing, is provided via movement generator 106.

The input of recording 116 featuring visuals of notes 118 and, optionally, audio 120 may be received by data acquisition module 108, which is part of a user interface (e.g., a graphical user interface). In some aspects, notes 118 may additionally be provided in a separate text document (e.g., a PDF document). For example, recording 116 may show the writer writing a first portion of notes, erasing the first portion to create space, and then writing a second portion of notes in the created space. Notes 118 may include each portion in a different page of the text document.

Data parsing module 110 generates a table that separates each of the different types of inputs in recording 116 and notes 118. For example, data parsing module 110 may convert the PDF document into an XML format in which text and images are separated into different columns.

Tracking module 112 then analyzes recording 116 and identifies timestamps and coordinates of the cursor as notes 118 are written. For example, the notes writer may be using a tablet pen to write notes on a touch sensitive screen. Tracking module 112 may determine where the cursor travels when writing to determine a plurality of coordinates along which the notes writer moves his/her hand.

Tracking module 112 may then create a curve by connecting the determined coordinates. In some aspects, tracking module 112 may adjust the curve in order to improve the drawing style (e.g., improve visualization of a track) of the handwritten notes/equations. For example, data parsing module 110 may smooth out the handwriting in notes 118 and tracking module 112 may thus smooth the generated curve. In some aspects, data parsing module 110 may convert informal handwriting to formalized handwriting (e.g., preferred font used for all lectures). Data parsing module 110 may rely, for example, on a neural network-based handwriting synthesis library for technical writings/drawings. Data parsing module 110 may further change the colors in notes 118.

In some aspects, tracking module 112 may increase the speed of traversing through the curve. For example, tracking module 112 may down-sample certain coordinates to increase the handwriting speed by a certain percentage (e.g., 20% faster writing).

In an exemplary aspect, the hand of the avatar has an additional weight. In other words, the hand is a virtual weighed object that traces the writing track and smooths out the movement. In some aspects, the virtual weighted object has parameters such as inertial mass. By adjusting the inertial mass, the movement generator 106 is able to deal with various levels of tremor in the handwriting.

Consider an example where recording 116 captures an actual person writing notes (rather than a basic cursor). In such an example, tracking module 112 may scan, using object detection techniques (e.g., a machine learning classifier) recording 116 for a hand in a writing posture. Tracking module 112 may further use a pose detection algorithm to identify multiple keypoints in the detected hand. The keypoints may include, but are not limited to, the tip of each finger, the knuckles, any bendable points in each finger, the wrist bone, etc. For each point in time (e.g., each frame or every X number of frames in recording 116), tracking module 112 stores a coordinate of each keypoint. Ultimately, tracking module 112 captures a track (e.g., coordinates over time) of handwritings and drawings, and stores them in a table. In some aspects, the table is in a CSV format.

In some aspects, the coordinates may be in a 3-D coordinate system and account for when the hand is lifted away from the writing surface. For example, recording 116 may include two views of the hand. The first video may be taken at a first angle that is behind the writer. The second video may be taken at a second angle that is at a side of the writer. By comparing timestamps, tracking module 112 is able to generate coordinates in a 3D plane indicative of where the hand is relative to the drawings/text and how far the hand is from the writing surface.

Animation module 114 is configured to transform 2D coordinates data (e.g. in a CSV format) into a 3D image for the avatar to follow. For example, animation module 114 may first generate an avatar 101 (e.g., a visual depiction of a lecturer). This may further involve generating a skeleton of an avatar 101 comprising a plurality of keypoints.

Animation module 114 may then animate the hand of avatar 101 to trace the handwriting or drawings of notes 118. This may involve adjusting the coordinates of the keypoints in avatar 101 in accordance with the curve generated by tracking module 112.

In an exemplary aspect, in addition to generating high-quality handwriting movements, movement generator 106 includes a co-speech engine 121 made up of speech recognition tool 122, tone recognition tool 124, and gesture module 126. The co-speech engine 121 receives audio 120 and curates the body language and gestures of the avatar 101 as it delivers a lecture. Without accounting for body language and gestures, the avatar 101 will appear robotic and lifeless—this may cause the user to find the avatar 101 as ineffective in teaching the material in recording 116.

Speech recognition tool 122 is configured to convert speech into text. Tone recognition tool 124 is configured to identify the tone with which the speech is delivered. Gesture module 126 is configured to determine the gestures that the avatar 101 is to perform based on the converted text and the identified tone.

The way a dialogue is delivered with different tones can significantly alter the accompanying gestures and body language, conveying entirely different emotions and intentions. For instance, consider the simple dialogue, “I can't believe you did that.” When delivered in an excited and happy tone, the speaker's body language might include wide eyes, a big smile, and raised eyebrows. Their hand gestures could involve raising their hands in the air or clapping, and their body posture would likely be open and relaxed, leaning forward with quick, energetic movements, possibly even bouncing on their toes.

In contrast, if the same dialogue is delivered in an angry and accusatory tone, the body language changes dramatically. The speaker might have furrowed brows, narrowed eyes, and tight lips. Their hand gestures could include pointing a finger, clenching fists, or placing hands on hips. The body posture would be stiff and rigid, possibly leaning forward aggressively, with sharp, abrupt movements, potentially stepping closer to the person being addressed. Similarly, a disappointed and sad tone would result in downturned mouth, sad eyes, and furrowed brows, with hands loosely hanging by the sides or gently gesturing downward. The posture would be slumped, with slow, minimal movements, possibly stepping back or turning away slightly.

In each scenario, the same words are spoken, but the tone of voice dramatically changes the accompanying body language and gestures, thereby altering the overall message and emotional impact. This illustrates how crucial tone and non-verbal cues are in communication.

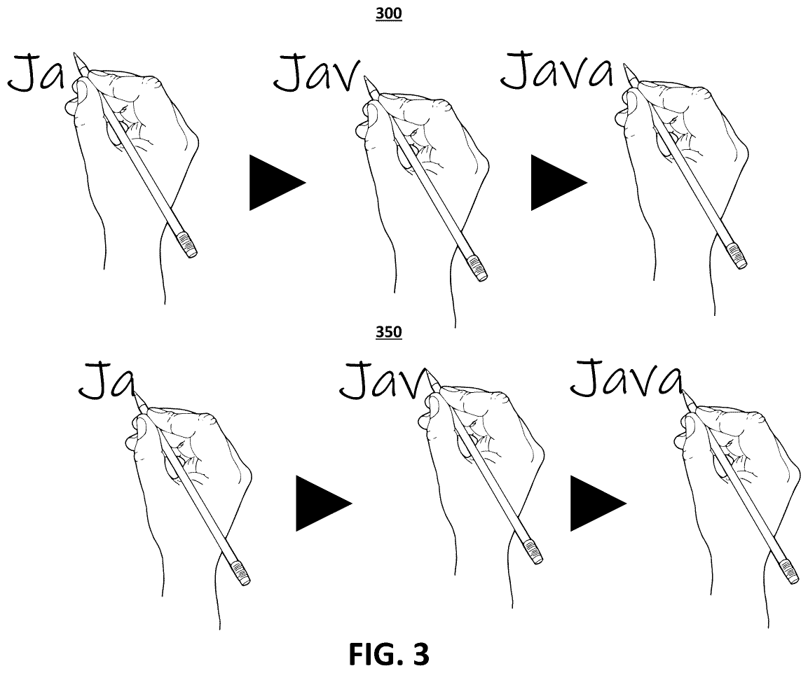

FIG. 3 is a diagram 300 illustrating a comparison of two writing sequences. In diagram 200, the term “Biological” is being written, but hand 208 is simply hovering in an illogical manner. This corresponds to conventional approaches to simulating handwriting. For example, the pen is not touching the letters and the movement of the hand is randomized.

In sequence 350, the movement is generated by movement generator 106. Accordingly, hand 208 follows the logical motion for writing each letter using the learned curve.

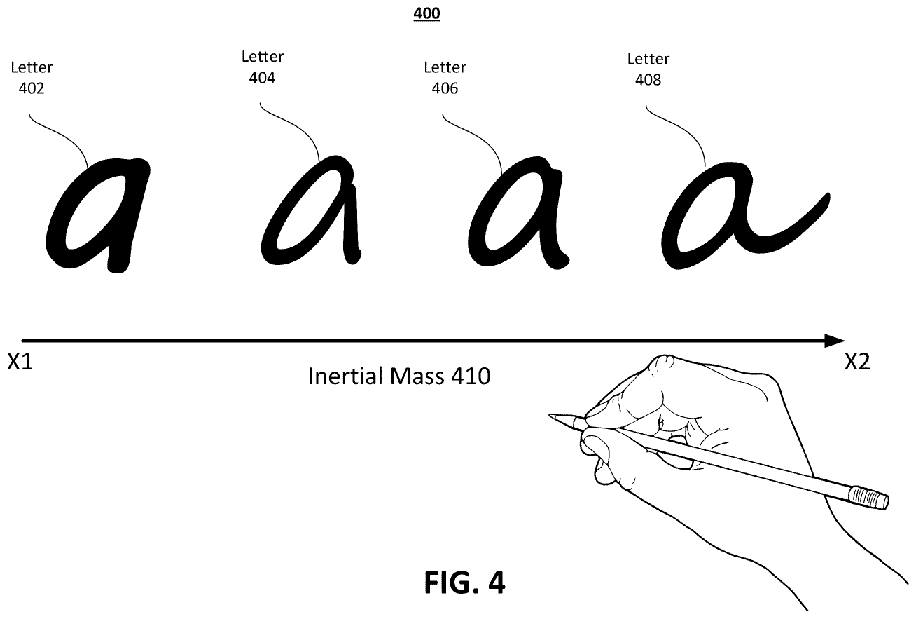

FIG. 4 is a diagram 400 illustrating an avatar drawing a graphic at different inertial masses. As mentioned previously, adjusting an inertial mass of hand 208 affects the path that hand 208 takes in an animation. For example, if inertial mass 410 is set to a value X1 (e.g., 1 out of 10), hand 208 draws letter 402 in a rigid and controlled manner. As inertial mass 410 increases, the letters become looser and because hand 208 has greater sway. In particular, this is showcased by letters 404, 406, and 408 having increasingly longer tails as inertial mass 410 increases. Consider a scenario in which a heavy hand and a lighter hand are writing the letter “a” at the same speed (e.g., within 0.5 seconds). The heavier hand will have greater sway than the lighter hand (i.e., one with less inertial mass) as it accelerates and decelerates because it requires more force to start, stop, and change direction. From a biological standpoint, the muscles and joints of the heavier hand must work harder to stabilize the hand, and any slight inefficiency in this control can result in increased swaying.

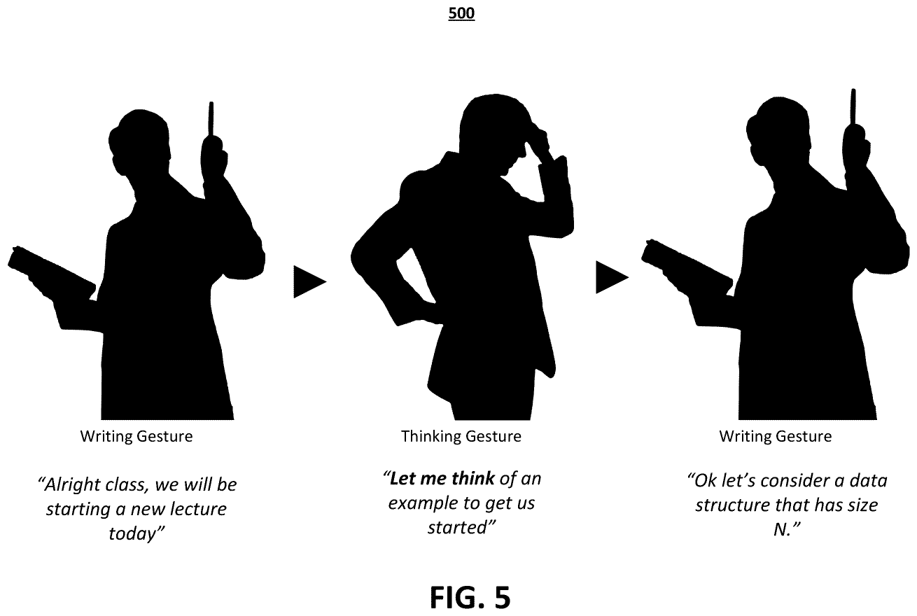

FIG. 5 is a diagram 500 illustrating an avatar 101 performing a sequence of gestures based on the dialogue being output. As mentioned previously, co-speech engine 121 curates the body language and gestures of the avatar 101. As avatar 101 writes notes, it should be noted that certain dialogue in audio 120 (which accompanies or is a part of recording 116) may be delivered by a lecturer when he/she is not writing notes 118. For example, a professor may write a portion of notes 118 and explain them aloud. After writing down the portion, the professor may provide additional insight regarding the concept captured by the portion, but do so without writing additional notes. Avatar 101 may be animated to perform a writing gesture, followed by additional gestures during the professor's monologue.

In FIG. 5, for example, diagram 500 showcases a simple sequence in which avatar 101 states (1) “Alright class, we will be starting a new lecture today,” (2) “Let me think of an example to get us started,” and (3) “Ok let's consider a data structure that has size N.” This dialogue may be extracted from audio 120. In some aspects, the avatar 101 simply performs a motion while audio 120 plays in the final output to the user. In some aspects, co-speech engine 121 may extract the dialogue from audio 120 (convert speech to text) and then convert the dialogue to audio using a speech generation engine. In the latter aspect, the voice, tone, and speed of delivery of the avatar 101 can be adjusted. Suppose that when stating (1) and (3), notes 118 are being written. Accordingly, a writing gesture may be selected by co-speech engine 121. During this writing gesture, the realistic handwriting motion may be animated by movement generator 106 (as described previously). When the avatar 101 is delivering statement (2), where no notes are being written according to recording 116, co-speech engine 121 selects a gesture from a plurality of gestures that should accompany the statement. In an exemplary aspect, the gesture is selected based on keywords in the statement. For example, the keyword/keyphrase in statement (2) is “let me think,” which may be mapped in co-speech database 128 to a thinking gesture. Animation module 114 then animates avatar 101 to perform the thinking gesture when reciting statement (2).

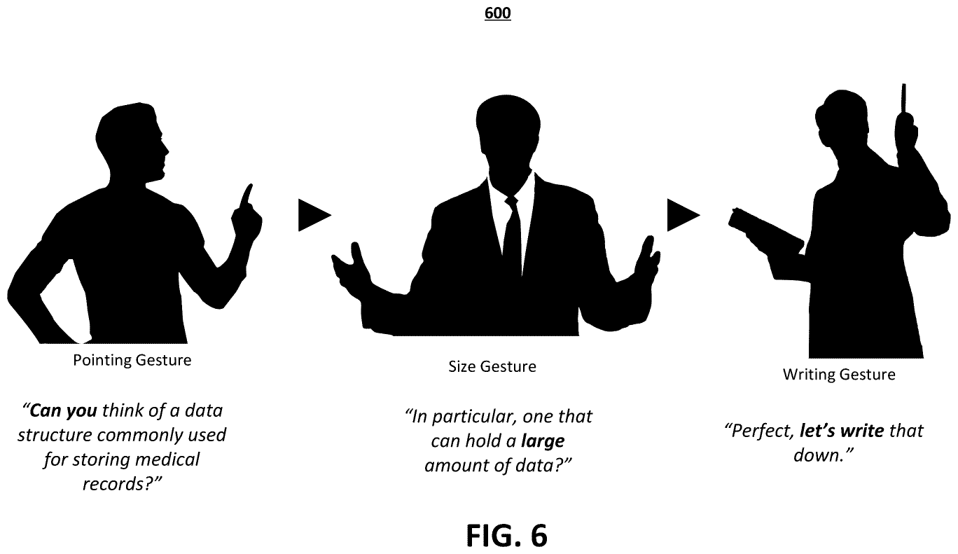

FIG. 6 is a diagram 600 illustrating an avatar performing another sequence of gestures based on the dialogue being output. In the sequence of diagram 600, avatar 101 is configured by co-speech engine 121 to perform a pointing gesture when stating “can you think of a data structure commonly used for storing medical records?” Here, the keywords are “can you.” Subsequently, co-speech engine 121 may select a sizing gesture when avatar 101 recites “in particular, one that can hold a large amount of data? ” Here, the keyword that prompts the selection of the sizing gesture is “large.” Lastly, when stating “perfect let's write that down,” the writing gesture is selected once again.

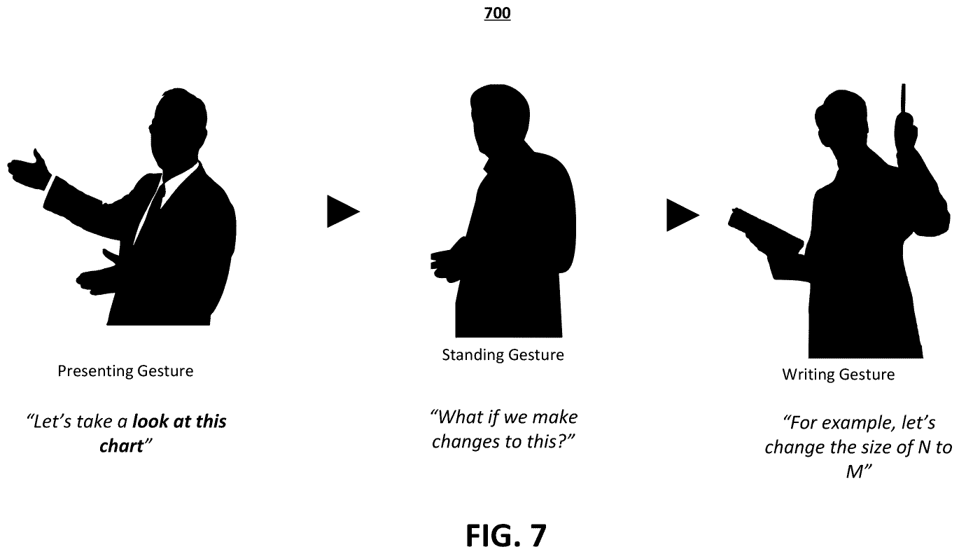

FIG. 7 is a diagram 700 illustrating an avatar performing yet another sequence of gestures based on the dialogue being output. In this sequence, co-speech engine 121 first selects a presenting gesture when the keywords “look at this” are stated. Subsequently, a standing gesture (a default gesture) is selected when the statement “what if we make changes to this?” includes no known keywords and new notes are not being written. When notes are written again, the writing gesture is selected by co-speech engine 121.

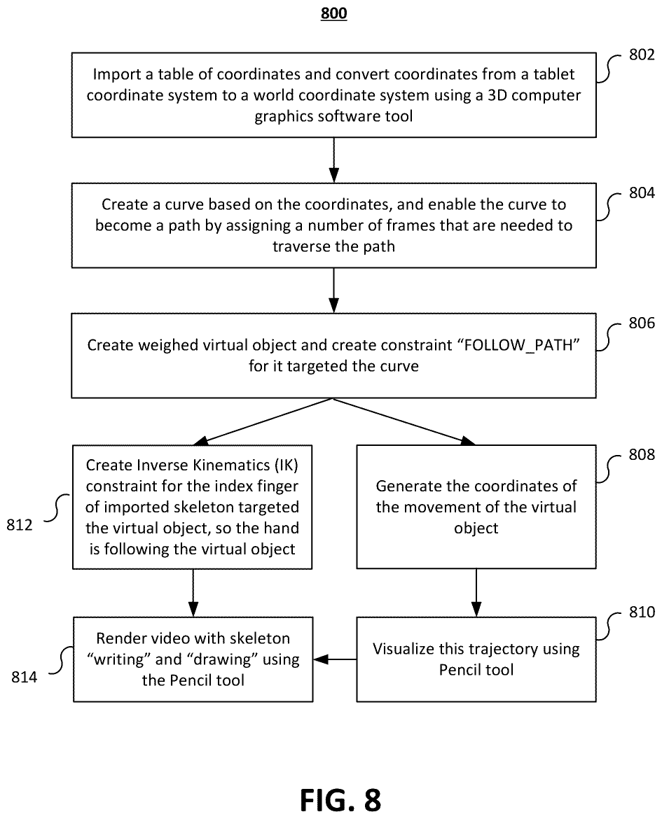

FIG. 8 illustrates a flow diagram of a method 800 for rendering a video of an avatar with realistic handwriting movements. At 802, movement generator 106 imports a table of coordinates (e.g. in a CSV format) and converts coordinates from a tablet coordinate system to a world coordinate system using a 3D computer graphics software tool (e.g., Blender).

At 804, movement generator 106 creates a curve based on these coordinates, and enables the curve to become a path by assigning a number of frames that are needed to traverse the path. At 806, movement generator 106 creates a weighed virtual object and creates a constraint “FOLLOW_PATH” for it targeted the curve.

Method 800 then divides into two branches, which may be executed in parallel, connecting only through the virtual object created in 806. The left branch is aimed at hand movement, and the right branch is aimed at visualizing curves. For example, at 808, movement generator 106 generates the coordinates of the movement of the virtual object. At 810, movement generator 106 visualizes this trajectory using a pencil tool.

At 812, movement generator 106 creates an Inverse Kinematics (IK) constraint for the index finger of imported skeleton targeting the virtual object, so the hand is following the virtual object. At 814, movement generator 106 renders a video with the avatar “writing” and “drawing” using a pencil tool.

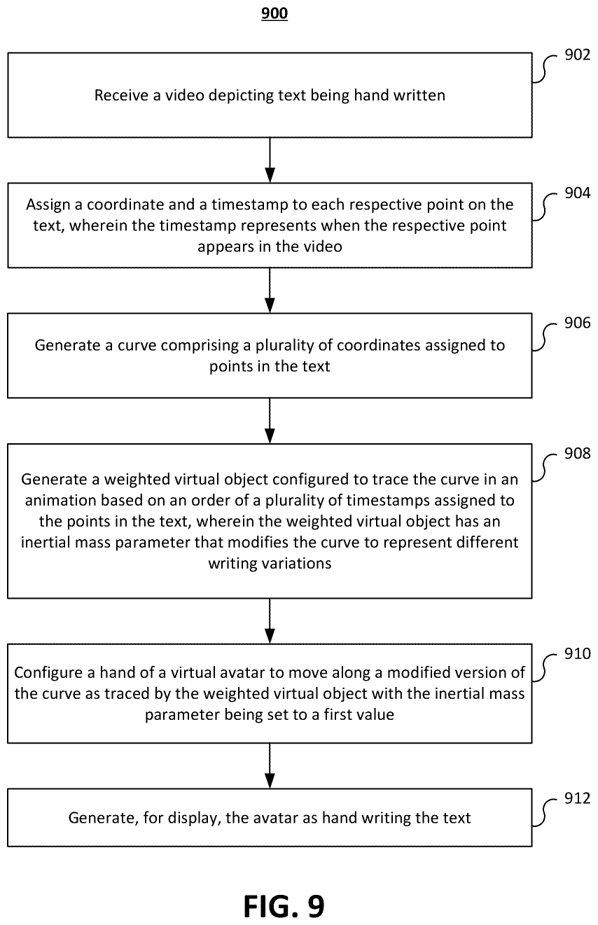

FIG. 9 illustrates a flow diagram of method 900 for generating realistic handwriting movements for a virtual avatar. At 902, data acquisition module 108 receives a video (e.g., recording 116) depicting text being hand written. For example, the video may depict a blank page that fills the screen. Over time, text/drawings may appear on the blank page in a manner resembling handwriting. In some aspects, video may depict a physical hand making markings on the blank page using a writing tool (e.g., a pen, a pencil, etc.).

At 904, tracking module 112 may assign a coordinate and a timestamp to each respective point on the text. For example, if the letter “a” is written on the blank page, tracking module 112 may determine that the letter is composed of a plurality of individual points, each with a coordinate (e.g., location of its corresponding pixel) and timestamp representing when the respective point appears in the video (e.g., Point A has coordinates (X, Y) and appears 5 seconds from the start of the video).

At 906, tracking module 112 generates a curve comprising a plurality of coordinates assigned to points in the text. For example, tracking module 112 may connect each of the points across multiple letters. It should be noted that even when the writer lifts his/her hand to transition to another word, the last point on the previously written letter is connected by tracking module 112 to the first point on the subsequently written letter. This is because the curve represents a path of the hand. In some aspects, the connection between the last point and the first point described above is a straight line.

At 908, animation module 114 generates a weighted virtual object configured to trace the curve in an animation based on an order of a plurality of timestamps assigned to the points in the text. For example, the weighted object may be a placeholder for the hand of the avatar. The motion of the weighted object is determined by a combination of the timestamps, the generated curve, and an inertial mass parameter that modifies the curve to represent different writing variations. The timestamps are used to provide an order in which the curve is to be traced (e.g., start with point 1, then point 2, etc.). The inertial mass parameter affects how closely the curve is followed. As mentioned previously, higher inertial mass will cause greater deviation from the curve because heavier hands require greater force for stabilization. If the curve is to be traced within the time period spanning the timestamps of the plurality of coordinates (e.g., within 10 seconds), the speed of writing is constant. As inertial mass parameter is increased while the speed is kept constant, greater sway is expected in the movement of the weighed virtual object.

At 910, animation module 114 configures a hand of a virtual avatar to move along a modified version of the curve as traced by the weighted virtual object with the inertial mass parameter being set to a first value. In some aspects, the inertial mass parameter may be a numerical value within a certain range (e.g., 1 to 10, 1% to 100%). In some aspects, the range may represent the mass of a human hand (e.g., 100 grams to 600 grams). In one example, the first value may be 400 grams.

In terms of animating the hand, animation module 114 may create or import 3D models of a hand and a writing tool (e.g., a pencil) into a 3D animation software (e.g., Blender). These 3D models may include a rig (e.g., a skeleton with joints) that allows for realistic movement of the fingers and wrist. The rig specifically includes bones and joints for each finger segment and the wrist. Animation module 114 may further set up inverse kinematics for the fingers and wrist to allow for natural movement.

Animation module 114 may further position the pencil in the hand as it would be held naturally. This involves parenting the pencil to the hand so that it moves with the hand. This can be done by directly parenting the pencil to the hand bone or using constraints to attach the pencil to the hand, allowing for more control. When animating the hand to follow the modified curve, animation module 114 may create the modified curve in the 3D animation software (e.g., using a curve tool in Blender). Animation module 114 may select the hand or the pencil and add a “Follow Path” constraint, wherein the target is the modified curve. Animation module 114 may then animate the offset of the “Follow Path” constraint to move the hand along the path and adjust the hand and finger positions to ensure the pencil tip follows the path accurately. This may involve keyframing the hand and finger bones. Lastly, animation module 114 may set up camera and lighting, and render the animation.

At 912, animation module 114 generates, for display, the avatar as hand writing the text.

In some aspects, animation module 114 may receive a request to change the inertial mass parameter to a second value. For example, the user may want the hand to have a heavier feel (e.g., second value equaling 600 grams). This causes a change in the curve that the hand will follow (e.g., due to greater sway). Animation module 114 may then configure the hand of the virtual avatar to move along a different modified version of the curve as traced by the weighted virtual object with the inertial mass parameter being set to the second value. Here, a difference between the curve the modified version of the curve is less than a difference between the curve and the different modified version of the curve. This is because the higher inertial mass parameter causes greater deviation from the curve by the tracing performed by the weighed virtual object.

In some aspects, when creating a path of the weighted virtual object, animation module 114 modifies the curve to the modified version of the curve by executing a machine learning model configured to receive an input value of the inertial mass parameter and an input curve, and output a modified version of the input curve based on the input value of the inertial mass parameter. In some aspects, the machine learning model is trained on a dataset comprising a plurality of input vectors each comprising a known input value of the inertial mass parameter (e.g., 428 grams) and a known input curve (e.g., a curve comprising the written letter “a”) as input parameters, and a modified version of the known input curve as an output parameter (e.g., a tracing of the sine curve by a hand that weighs 428 grams). More specifically, the known input value represents a mass value of a physical hand, the known input curve is a curve that the physical hand is to trace, and the modified version of the known input curve is a tracing performed by the physical hand of the known input curve within a threshold period of time (e.g., 1 second). With a variety of input/output curves and hand weights, the machine learning model learns how deviation from an input curve looks like.

It should be noted that due to the deviation from the original curve, there may be additional points in the text written by the avatar that does not appear in the text in the video. For example, the letter “a” may appear as letter 402 in the video and may appear as letter 408 in the text written by the avatar. In order to make the adjustment in the video comprising the avatar, another machine learning model may be executed that is trained to fit an input text (e.g., notes 118) along the modified curve. For example, the another machine learning model may be trained on a training dataset comprising training vectors, each of which include an input text, an input curve, and an output fitted text comprising the input text written within the constraints of the input curve.

In some aspects, data parsing module 110 may modify a visual characteristic of the text prior to assigning a coordinate and a timestamp to each respective point on the text. The visual characteristic may be one or more of: a text size, a font, a color, and an amount of characters.

In some aspects, tracking module 112 may also apply a smoothing filter to the curve prior to modifying the curve to the modified version using the weighted virtual object. For example, tracking module 112 may apply one or more of a moving average filter, a Gaussian filter, a Savitzky-Golay filter, or a spline filter to the coordinates in the curve to soften sharp transitions (e.g., where the slope between neighboring points changes by a threshold amount).

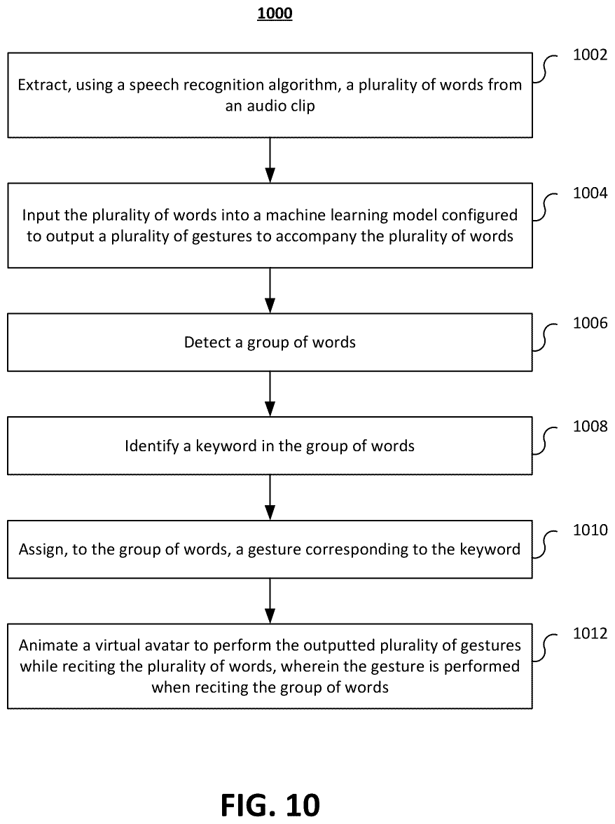

FIG. 10 illustrates a flow diagram of a method 1000 for animating realistic movements in an avatar using a co-speech engine. At 1002, speech recognition tool 122 extracts, using a speech recognition algorithm, a plurality of words from an audio clip (e.g., audio 120). In some aspects, speech recognition tool 122 may perform preprocessing on the audio clip to reduce background noise and enhance the quality of the speech signal. The continuous audio stream is then segmented into smaller frames (e.g., 20-40 milliseconds each). During feature extraction, speech recognition tool 122 derives acoustic features like Mel-Frequency Cepstral Coefficients (MFCCs) from each frame to represent the speech signal. Speech recognition tool 122 may also employ spectrogram analysis to identify patterns corresponding to different phonemes. These features are then fed into a phoneme recognition model (e.g., a pre-trained neural network), which classifies each frame into one of the possible phonemes. Contextual information is utilized to improve the accuracy of phoneme recognition by considering the likelihood of certain phoneme sequences.

In the word recognition phase, a language model is integrated to convert the sequence of phonemes into words, predicting the most likely words based on the recognized phonemes and their context. The recognized phonemes are matched against a dictionary of known words to form coherent words. Speech recognition tool 122 may further employ decoding algorithms, such as the Viterbi algorithm, to find the most likely sequence of words from the sequence of phonemes, considering both the acoustic model and the language model. Post-processing steps include error correction mechanisms, such as spell-checking and grammar correction, to refine the recognized text. Furthermore, speech recognition tool 122 may format the recognized words with appropriate punctuation and capitalization to produce a readable text output. By combining these steps, speech recognition tool 122 effectively transforms spoken language in audio 120 into written text with a high degree of accuracy.

At 1004, gesture module 126 inputs the plurality of words into a machine learning model comprised in the gesture module 126. The machine learning module is trained to output a plurality of gestures to accompany the plurality of words. There may be different types of gestures in the training dataset, including, but not limited to:
Enumerative: For gestures indicating quantity or distribution (keywords: “multiple”, “each”, “every”).
Ordinal: For gestures that signify order or sequence (keywords: “firstly”, “secondly”).
Self-Indication: For gestures that refer to oneself (keywords: “I”, “my”, “right now”).
Expansive: For gestures involving arms spread wide to denote magnified qualities or sizes (e.g., “very long,” “very big”), specifically capturing the action of spreading arms to indicate magnitude.
Negatory: For gestures that indicate negation or denial (keywords: “not,” “don't”).
Counterpart-indication: you, your, they, their, etc.

### High/Low

In some aspects, the machine learning model is trained on a dataset comprising input groups of words each preassigned to an output gesture. A sample input vector in the training dataset may be “-1_wayne_0_8_8_segment_27000_28400/Secondly/” where “1_wayne_0_8_8_segment_27000_28400” represents a particular animated gesture and “secondly” is the keyword mapped to the gesture.

The machine learning model may be trained through a supervised learning process. Initially, a large dataset comprising pairs of text inputs and corresponding gestures is collected. This dataset includes various sentences or phrases where specific keywords are tagged with their associated gestures. The model (e.g., a neural network) is then trained on this dataset. During training, the algorithm learns to identify patterns and associations between the keywords and the gestures. For example, if the key “wave” frequently appears in sentences where the gesture is a hand wave, the algorithm learns to identify the word “wave” as a keyword and further maps “wave” with the hand-waving gesture. The training process involves adjusting the model's parameters to minimize the error between its predicted gestures and the actual gestures in the training data. Once trained, the algorithm can take a new input group of words, detect the presence of keywords, and output the corresponding gesture.

At 1006, the machine learning model detects a group of words. In some aspects, the group of words is a phrase and/or a complete sentence. Referring to FIG. 6, the entire dialogue may be “can you think of a data structure commonly used for storing medical records? In particular, one that can hold a large amount of data? Perfect, let's write that down.” In this example, the machine learning model may perform segmentation and identify (e.g., based on grammar), three groups of words.

For simplicity, only one group will be focused on (e.g., “in particular, one that can hold a large amount of data.”). At 1008, the machine learning model may identify a keyword in the group of words. In some aspects, the machine learning model may rely on a pre-existing database such as the co-speech database 128, which may include a plurality of keywords and a plurality of tones. Each combination of keywords and tones may be mapped to a particular gesture. In some aspects, co-speech database 128 may also map keywords to gestures directly for cases where tone cannot be determined.

Suppose that the identified keyword is “large.” The machine learning algorithm may then, at 1010, assign, to the group of words, a gesture corresponding to the keyword “large.” In this case, the gesture may be a sizing gesture in which the avatar extends its hands in opposite directions (as shown in FIG. 6).

At 1012, animation module 114 may animate a virtual avatar 101 to perform the outputted plurality of gestures while reciting the plurality of words, wherein the gesture is performed when reciting the group of words. As mentioned previously, animation module 114 has a rig of avatar 101. In order to animate the virtual avatar, animation module 114 may utilize keyframe animation, in which animation module 114 sets key positions (keyframes) for the avatar 101 at specific points in time, defining critical moments of the gesture.

In some aspects, the gesture is initiated by the avatar when reciting the keyword in the group of words. For example, animation module 114 may interpolate the frames between these key positions to create smooth transitions. For instance, if the avatar 101 is to extend its hands while saying “large” in accordance with the sizing gesture, animation module 114 sets keyframes at the start of the hand-extending motion, at the peak of the gesture, and at the end when the hand is fully extended. The timing of these keyframes is carefully aligned with the phonetic breakdown of the speech to ensure that the gesture peaks at the appropriate moment in the dialogue.

In some aspects, the plurality of words are each assigned a timestamp based on an occurrence in the audio clip. For example, the term “large” may be said 10 seconds into audio 120. Gesture module 126 may input, in the machine learning model, timestamps assigned to the plurality of words. Accordingly, the machine learning model may be configured to generate an output time period for each of the plurality of gestures. The output time period may start from a first timestamp of when the group of words begins to a second timestamp of when the group of words ends. As a result, the virtual avatar performs the plurality of gestures at a pace matching the audio clip.

In some aspects, the output time period may start from a first timestamp that is a threshold time period away from when the keyword recitation begins to a second timestamp of when the recitation ends.

In some aspects, tone recognition tool 124 may determine a tone of a voice speaking the plurality of words in the audio clip. For example, the speaker may be angry, sad, happy, etc. Gesture module 126 may then input, in the machine learning model, a tone of the plurality of words, wherein the machine learning model is further configured to select the plurality of gestures based on the tone such that the group of words stated in a first tone are assigned the gesture and the group of words stated in a second tone are assigned a different gesture. For example, if the keyword is “great” and the tone is “happy,” the gesture may be a “thumbs up.” If the keyword is “great,” but the tone is “sarcastic,” the gesture may be “shrug.”

In some aspects, the dataset comprises a plurality of gesture variations for a given group of words. This prevents the same animation of a gesture from repeating multiple times whenever the same keyword is reused. The machine learning model may select a different variation for each time the same keyword is used so that there is added nuance to the body language of avatar 101.

FIG. 11 is a block diagram illustrating a computer system 20 on which aspects of systems and methods for generating realistic movements for a virtual avatar may be implemented in accordance with an exemplary aspect. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-10 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for generating realistic movements for a virtual avatar, the method comprising:
extracting, using a speech recognition algorithm, a plurality of words from an audio clip;
inputting the plurality of words into a machine learning model configured to output a plurality of gestures to accompany the plurality of words, wherein the machine learning model is configured to:
detect a group of words;
identify a keyword in the group of words; and
assign, to the group of words, a gesture corresponding to the keyword; and
animating a virtual avatar to perform the outputted plurality of gestures while reciting the plurality of words, wherein the gesture is performed when reciting the group of words.

2. The method of claim 1, wherein the group of words is a phrase and/or a complete sentence.

3. The method of claim 1, wherein the plurality of words are each assigned a timestamp based on an occurrence in the audio clip, further comprising:
inputting, in the machine learning model, timestamps assigned to the plurality of words, wherein the machine learning model is configured to generate an output time period for each of the plurality of gestures, wherein the output time period starts from a first timestamp of when the group of words begins to a second timestamp of when the group of words ends, and
wherein the virtual avatar performs the plurality of gestures at a pace matching the audio clip.

4. The method of claim 1, further comprising:
determining a tone of a voice speaking the plurality of words in the audio clip;
inputting, in the machine learning model, a tone of the plurality of words, wherein the machine learning model is configured to select the plurality of gestures based on the tone such that the group of words stated in a first tone are assigned the gesture and the group of words stated in a second tone are assigned a different gesture.

5. The method of claim 1, wherein the machine learning model is trained on a dataset comprising input groups of words each preassigned to an output gesture.

6. The method of claim 5, wherein the dataset comprises a plurality of gesture variations for a given group of words.

7. The method of claim 1, wherein the gesture is initiated by the avatar when reciting the keyword in the group of words.

8. A system for generating realistic movements for a virtual avatar, comprising:
at least one memory;
at least one hardware processor coupled with the at least one memory and configured, individually or in combination, to:
extract, using a speech recognition algorithm, a plurality of words from an audio clip;
input the plurality of words into a machine learning model configured to output a plurality of gestures to accompany the plurality of words, wherein the machine learning model is configured to:
detect a group of words;
identify a keyword in the group of words; and
assign, to the group of words, a gesture corresponding to the keyword; and
animate a virtual avatar to perform the outputted plurality of gestures while reciting the plurality of words, wherein the gesture is performed when reciting the group of words.

9. The system of claim 8, wherein the group of words is a phrase and/or a complete sentence.

10. The system of claim 8, wherein the plurality of words are each assigned a timestamp based on an occurrence in the audio clip, wherein the at least one hardware processor is further configured to:
input, in the machine learning model, timestamps assigned to the plurality of words, wherein the machine learning model is configured to generate an output time period for each of the plurality of gestures, wherein the output time period starts from a first timestamp of when the group of words begins to a second timestamp of when the group of words ends, and
wherein the virtual avatar performs the plurality of gestures at a pace matching the audio clip.

11. The system of claim 8, wherein the at least one hardware processor is further configured to:
determine a tone of a voice speaking the plurality of words in the audio clip;
input, in the machine learning model, a tone of the plurality of words, wherein the machine learning model is configured to select the plurality of gestures based on the tone such that the group of words stated in a first tone are assigned the gesture and the group of words stated in a second tone are assigned a different gesture.

12. The system of claim 8, wherein the machine learning model is trained on a dataset comprising input groups of words each preassigned to an output gesture.

13. The system of claim 12, wherein the dataset comprises a plurality of gesture variations for a given group of words.

14. The system of claim 8, wherein the gesture is initiated by the avatar when reciting the keyword in the group of words.

15. A non-transitory computer readable medium storing thereon computer executable instructions for generating realistic movements for a virtual avatar, including instructions for:
extracting, using a speech recognition algorithm, a plurality of words from an audio clip;
inputting the plurality of words into a machine learning model configured to output a plurality of gestures to accompany the plurality of words, wherein the machine learning model is configured to:
detect a group of words;
identify a keyword in the group of words; and
assign, to the group of words, a gesture corresponding to the keyword; and
animating a virtual avatar to perform the outputted plurality of gestures while reciting the plurality of words, wherein the gesture is performed when reciting the group of words.

16. The non-transitory computer readable medium of claim 15, wherein the group of words is a phrase and/or a complete sentence.

17. The non-transitory computer readable medium of claim 15, wherein the plurality of words are each assigned a timestamp based on an occurrence in the audio clip, further comprising instructions for:
inputting, in the machine learning model, timestamps assigned to the plurality of words, wherein the machine learning model is configured to generate an output time period for each of the plurality of gestures, wherein the output time period starts from a first timestamp of when the group of words begins to a second timestamp of when the group of words ends, and
wherein the virtual avatar performs the plurality of gestures at a pace matching the audio clip.

18. The non-transitory computer readable medium of claim 15, further comprising instructions for:
determining a tone of a voice speaking the plurality of words in the audio clip;
inputting, in the machine learning model, a tone of the plurality of words, wherein the machine learning model is configured to select the plurality of gestures based on the tone such that the group of words stated in a first tone are assigned the gesture and the group of words stated in a second tone are assigned a different gesture.

19. The non-transitory computer readable medium of claim 15, wherein the machine learning model is trained on a dataset comprising input groups of words each preassigned to an output gesture.

20. The non-transitory computer readable medium of claim 19, wherein the dataset comprises a plurality of gesture variations for a given group of words.
